(19) United States
(12) Patent Application Publication
(10) Pub. No.: US 2013/0021904 A1
(43) Pub. Date: Jan. 24, 2013

(54) SYSTEM AND METHOD FOR CONGESTION CONTROL IN A CORE NETWORK

(71) Applicants: Michael F. Dolan, Bolingbrook, IL (US); David A. Rossetti, Randolph, NJ (US)

(72) Inventors: Michael F. Dolan, Bolingbrook, IL (US); David A. Rossetti, Randolph, NJ (US)

(73) Assignee: ALCATEL-LUCENT USA INC., Murray Hill, NJ (US)

(21) Appl. No.: 13/186,800

(22) Filed: Jul. 20, 2011

(51) Int. Cl. H04W 28/02

(52) U.S. Cl. 370/230

(57) ABSTRACT

Embodiments provide a system and method for congestion control. The system includes a radio access network (RAN) including a network element, and a core network including a plurality of gateways. The network element is configured to receive a connection request from an accessing device, where the connection request requests connection to a first gateway of the plurality of gateways, and the network element is included in the RAN. The network element is configured to obtain a priority of the accessing device and a threshold priority of the first gateway and grant the connection request based on the priority of the accessing device and the threshold priority of the first gateway.

### BACKGROUND

Machine-to-Machine (M2M) communications are spreading and growing rapidly. It is expected that there will be billions of new M2M devices attaching to wireless networks. This leads to congestion and overload situations, both at the radio access network (RAN) level, and in the core network.

Some wireless M2M devices are expected to operate at lower priorities than devices operated by human beings. The ability for the RAN to detect that an accessing device has a lower priority than a controllable threshold allows the RAN to reject accesses from that device, and perhaps inform the device of a waiting period before reattempting access to the network. However, the priority of an accessing device is not known until signaling occurs with the core network, the device's identity is determined, and subscription information can be retrieved.

A conventional solution is to create a connection from the RAN to a core network entity (e.g., a Packet Data Serving Node (PDSN) or a High Rate Packet Data Serving Gateway (HSGW)) that will further process the device's request for access, including authentication. However, this conventional solution requires that the core network become involved in signaling with the device via the RAN. If the core network entity is already in a congested or overloaded state, performing additional signaling and processing in order to reject a low priority device access adds to that congestion and overload condition.

### SUMMARY

Embodiments provide a system and method for congestion control. The system includes a radio access network (RAN) including a network element, and a core network including a plurality of gateways.

The network element is configured to receive a connection request from an accessing device, where the connection request requests connection to a first gateway of the plurality of gateways, and the network element is included in the RAN. The network element is configured to obtain a priority of the accessing device and a threshold priority of the first gateway. The network element is configured to grant the connection request based on the priority of the accessing device and the threshold priority of the first gateway.

In one embodiment, the network element is configured to grant the connection request if the priority of the accessing device is equal to or greater than the threshold priority of the first gateway, and the network element configured to deny the connection request if the priority of the accessing device is less than the threshold priority of the first gateway.

In one embodiment, the network element is configured to transmit an authentication request to authenticate an identity of the accessing device to an authentication server over a first interface in response to the connection request, where the first interface is an interface between the network element and the authentication server. The network element is configured to receive an authentication response including information indicating the priority of the accessing device in response to the authentication request if authentication is successful.

In other embodiment, the connection request includes information indicating an unauthenticated priority of the accessing device. In this embodiment, the network element is configured to determine the unauthenticated priority as the priority of the accessing device if the unauthenticated priority is below the threshold priority. However, if the unauthenticated priority is equal to or greater than the threshold priority, the network element is configured to transmit the authentication request and receive the authentication response including the information indicating the priority of the accessing device along the first interface.

The network element may be configured to receive information indicating the threshold priority from the first gateway over a second interface, where the second interface is an interface between the first gateway and the network element. Further, the network element is configured to receive the information indicating the threshold priority if the first gateway detects an overload condition.

In another embodiment, the network element is configured to obtain the threshold priority from a storage unit of the network element. Further, the network element is configured to obtain a different threshold priority from the storage unit at an indicated time.

In other embodiment, the network element is configured to grant a connection request to a second gateway of the plurality of gateways if (1) the network element denied the connection request to the first gateway and (2) the priority of the accessing device is greater than or equal to a threshold priority of the second gateway.

The network element may be configured to transmit information indicating network congestion and a time value indicating a time duration that the accessing device must wait before attempting to re-transmit the connection request if the network element denies the connection request.

In other embodiment, the network element includes an internal authentication mechanism that permits the network element to obtain the priority of the accessing device and the priority of the first gateway.

The network element may be one of a base station and radio network controller.

The method may include receiving, by a network element, a connection request from an accessing device, where the connection request requests connection to a first gateway of the plurality of gateways, and the network element is included in the RAN. The method further includes obtaining a priority of the accessing device and a threshold priority of the first gateway, and granting the connection request based on the priority of the accessing device and the threshold priority of the first gateway.

In one embodiment, the granting step further includes granting the connection request if the priority of the accessing device is equal to or greater than the threshold priority of the first gateway and/or denying the connection request if the priority of the accessing device is less than the threshold priority of the first gateway.

In one embodiment, the obtaining step further includes transmitting an authentication request to authenticate an identity of the accessing device to an authentication server over a first interface in response to the connection request, where the first interface is an interface between the network element and the authentication server, and receiving an authentication response including information indicating the priority of the accessing device in response to the authentication request if authentication is successful.

In one embodiment, the connection request includes information indicating an unauthenticated priority of the accessing device. In this embodiment, the obtaining step further includes determining the unauthenticated priority as the priority of the accessing device if the unauthenticated priority is below the threshold priority. However, if the unauthenticated priority is equal to or greater than the threshold priority, the obtaining step further includes transmitting the authentication request and receiving the authentication response including the information indicating the priority of the accessing device along the first interface.

In another embodiment, the obtaining step further includes receiving information indicating the threshold priority from the first gateway over a second interface, where the second interface is an interface between the first gateway and the network element. Further, the receiving step receives the information indicating the threshold priority when the first gateway detects an overload condition.

In another embodiment, the obtaining step further includes obtaining the threshold priority from a storage unit of a network element.

The system for congestion control in the core network may include a network element configured to receive a connection request from an accessing device, where the connection request requests connection to a first gateway of the plurality of gateways, and the network element is not included in the core network. The network element configured to obtain a priority of the accessing device and a threshold priority of the first gateway, and configured to grant the connection request based on the priority of the accessing device and the threshold priority of the first gateway.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting, and wherein:

FIG. 1 illustrates a wireless system for controlling congestion in a core network according to an embodiment;

FIG. 2 illustrates a method for controlling congestion in the core network according to an embodiment;

FIG. 3 illustrates a method for controlling congestion in the core network according to another embodiment; and

FIG. 4 illustrates a method for controlling congestion in the core network according to another embodiment.

### DETAILED DESCRIPTION OF EXAMPLE EMBODIMENTS

Various example embodiments will now be described more fully with reference to the accompanying drawings in which some example embodiments are shown. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two functions or acts shown in succession may in fact be executed concurrently or may sometimes be executed in the reverse order, depending upon the functionality/ acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

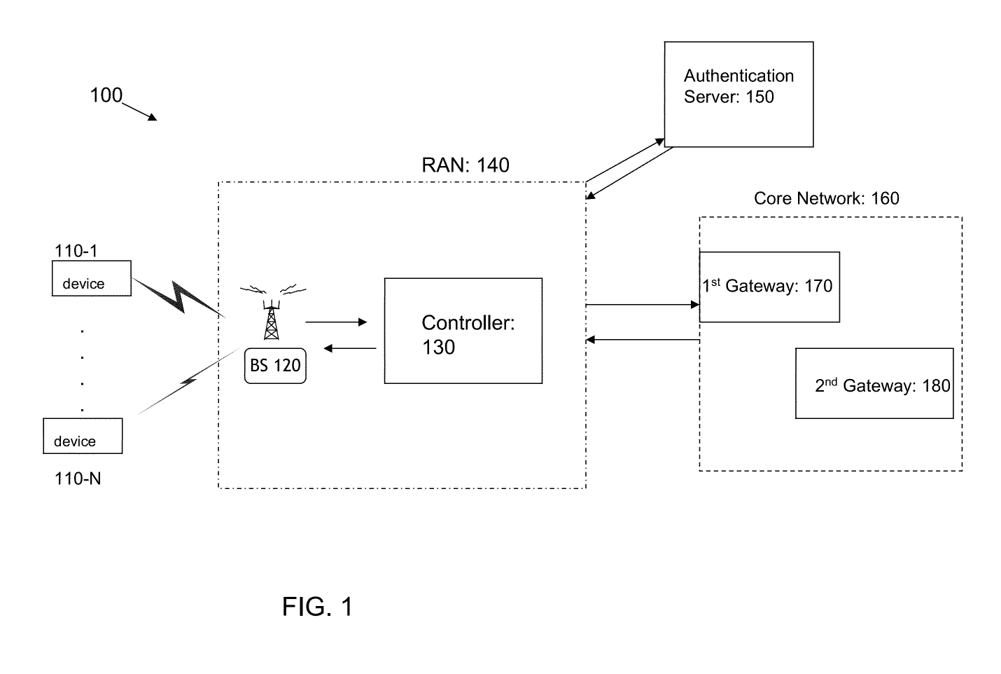

In the following description, illustrative embodiments will be described with reference to acts and symbolic representations of operations (e.g., in the form of flowcharts) that may be implemented as program modules or functional processes that include routines, programs, objects, components, data structures, etc., that when executed perform particular tasks or implement particular abstract data types and may be implemented using existing hardware at existing network elements. Such existing hardware (e.g., base station 120, controller 130, authentication server 150, first gateway 170 and second gateway 180, device 110 of FIG. 1) may include one or more Central Processing Units (CPUs), digital signal processors (DSPs), application-specific-integrated-circuits, field programmable gate arrays (FPGAs) computers or the like machines that once programmed become particular machines.

It should be borne in mind, however, that all of these and similar terms are to be associated with the appropriate physical quantities and are merely convenient labels applied to these quantities. Unless specifically stated otherwise, or as is apparent from the discussion, terms such as “comparing”, “granting”, “denying”, “obtaining”, “determining” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

As used herein, the term “device” or “accessing device” may be considered synonymous to, and may hereafter be occasionally referred to, as a terminal, mobile unit, mobile station, mobile user, user equipment (UE), subscriber, user, remote station, access terminal, receiver, etc., and may describe a remote user of wireless resources in a wireless communication network. Further, the term “device” or “accessing device” may include any type of wireless/wired device such as monitoring devices (e.g., sensors), consumer electronics devices, smart phones, personal digital assistants (PDAs), and computers, for example. Also, the term “device” or “accessing device” may be a high rate packet data (HRPD) device or any other type of high speed device.

The term base station (BS) may be considered synonymous to and/or referred to as a base transceiver station (BTS), NodeB, extended Node B (eNB), femto cell, access point, etc. and may describe equipment that provides the radio baseband functions for data and/or voice connectivity between a network and one or more users. The term “controller” may be a radio network controller (RNC) or base station controller (BSC) in wireless communication systems or any other type of controller that performs similar functions.

The embodiments of the present disclosure provide a system and method to obtain the priority information of an accessing device at an early stage in order to avoid additional signaling in the core network and to determine whether access is granted or denied based on the priority information. In one embodiment, a network element (e.g., a base station or controller in the RAN) uses an interface between an authentication server and the network element (e.g., A12 interface) to receive priority information of the accessing device, if authentication is successful.

FIG. 1 illustrates a wireless system 100 for controlling congestion in a core network 160 according to an embodiment.

The wireless system 100 provides wireless communication for devices 110-1 to 110-N connected to the wireless system, where N is an integer greater than or equal to two. The wireless system 100 includes a radio access network (RAN) 140 for connecting the devices 110 to the core network 160, an authentication server 150 to authenticate an identity of the devices 110, and a core network 160. The core network 160 includes at least a first gateway 170 and may include a second gateway 180, which provide functionality such as call routing, for example. However, the embodiments encompass any number of gateways in the core network 160 as well as any other component that is well known to one of ordinary skill in the art. The first gateway 170 and the second gateway 180 may be any type of gateway server within a core network such as a Packet Data Serving Node (PDSN) gateway or a HRPD Serving Gateway (HSGW), for example. The RAN 140 includes at least one base station 120 and a controller 130. The base station 120 and the controller 130 communicate with each other through methods that are well known to one of ordinary skill in the art. The RAN 140 also includes other components that are well known to one of ordinary skill in the art.

The authentication server 150 communicates with the RAN 140 to provide device level authentication for devices 110 requesting services from the service provider associated with operating the core network 160. For example, the authentication server 150 communicates with the controller 130 and/or the base station 120 in the RAN 140 to enable authentication and authorization functions to be performed in the RAN 140. The interface that permits this type of signaling between the RAN 140 and the authentication server 150 may be referred as the A12 interface.

The RAN 140 may be disposed between the core network 160 and the devices 110. The controller 130 and/or the base station 120 in the RAN 140 may communicate with the first gateway 170 and/or the second gateway 180 in the core network 160 via an air interface that supports signaling information between the RAN 140 and the core network 160 for packet data services and provides a signaling connection between the RAN 140 and the core network 160. This type of interface between elements in the RAN 140 and elements in the core network 160 may be referred to as the A11 interface.

The embodiments of the present applications are described with reference to the EV-DO protocol. However, the RAN 140 may follow one of a number of protocols including LTE or WiMax. As such, the type of base station and controller as well as the type of first gateway 170 and second gateway 180 may depend on the protocol of the RAN 140. For example, if RAN 140 follows the LTE protocol, the first gateway 170 and the second gateway 180 may be a packet data network gateway (P-GW) and/or a serving gateway (SGW) and the base station 120 may be an enodeB. If RAN 140 follows the WiMax protocol, the first gateway 170 and the second gateway 180 may be an access service network gateway (ASN-GW). If RAN 150 follows the EV-DO protocol, the first gateway 170 and the second gateway 180 may be a packet data serving node (PDSN) gateway or a high rate packet data serving gateway (HSGW).

The system 100 may include other components for the transfer of data that are well know such as a Mobility Management Entity (MME), and/or a Home Subscriber Server (HSS), for example. Data is relayed through the system 100 according to any type of standard protocol used to transfer data in a wireless type network.

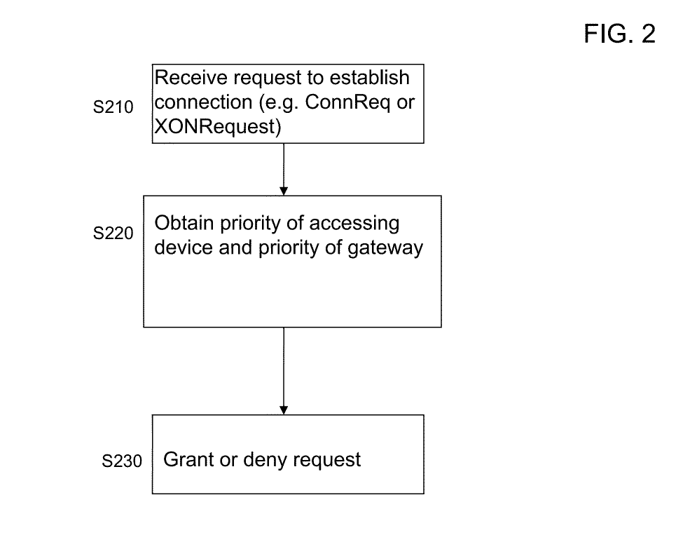

FIG. 2 illustrates a method for controlling congestion in the core network 160 according to an embodiment.

In step S210, a network element receives a connection request from a device such as device 110-1. The network element may be either the base station 120 or the controller 130. Further, the network element may be any other device in the RAN 140 capable of performing the following functions. Further, the network element is not an element included in the core network 160. The connection request may be sent from the device 110 to the RAN 140 when the device 110 wishes to establish a communication path between itself and the core network 160. For example, in one particular embodiment, when the device 110 has first established an air interface session in EV-DO, the device 100 may send an XonRequest to open flow control prior to the connection request.

In step S220, the network element obtains a priority of the device 110 and a threshold priority of the gateway the accessing device wishes to connect to such as the first gateway 170 or the second gateway 180.

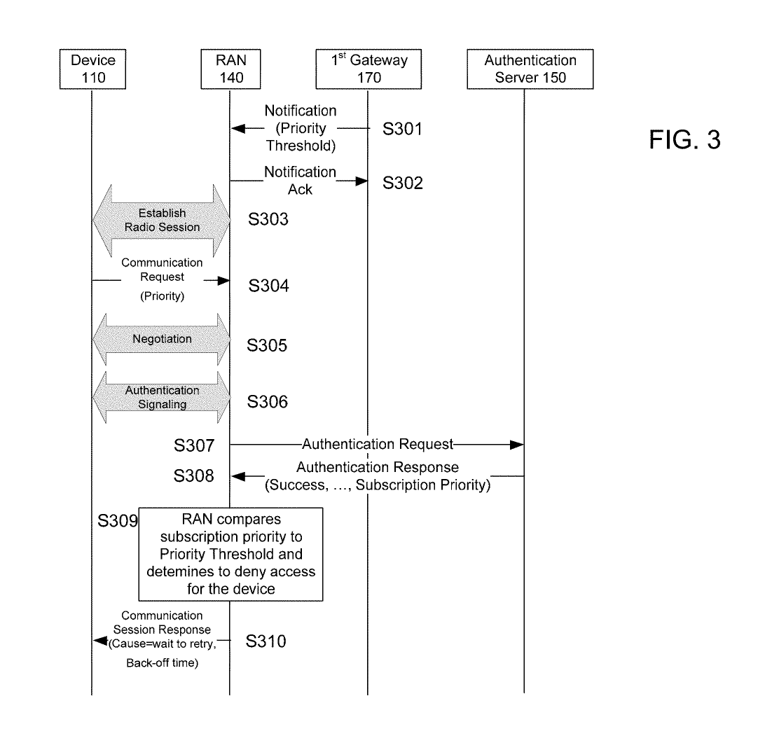

In one embodiment, the network element obtains the priority of the accessing device 110 via an interface (e.g., A12 interface) between the network element and the authentication server 150. For example, after elements in the RAN 140 receive information indicating that the device 110 wishes to connect to the core network 160, but before connecting the accessing device 110, the network element must first authenticate the identity of the accessing device 110. Therefore, the network element transmits an authentication request in order to authenticate the identity of the accessing device 110 to the authentication server 150 over the A12 interface. In response, the network element receives an authentication response from the authentication server 150 that includes conventional authentication information that indicates that the accessing device 110 is authenticated, or information that indicates that the accessing device is not authenticated. If the accessing device 110 is authenticated, in addition to the conventional authentication information, the authentication response includes information indicating the priority of the accessing device 110. In other words, the embodiments provide an additional field within an A12 message that carries the priority information of the accessing device 110. The authentication request and authentication response are shown and further discussed with reference to FIG. 3 of the present application.

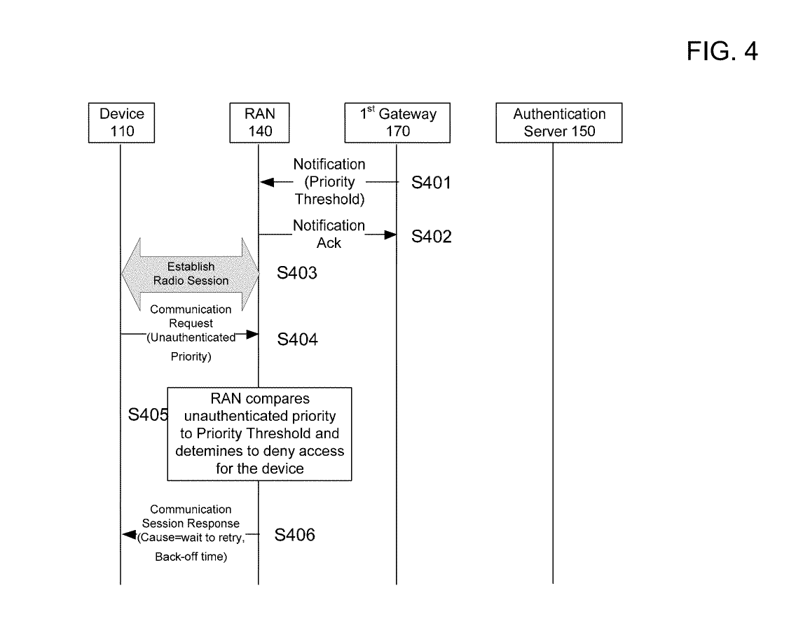

In another embodiment, the connection request itself contains information indicating an unauthenticated priority (e.g., priority that has not been authenticated by the authentication server 150). The network element may use the unauthenticated priority indicated in the connection request or may determine not to accept the unauthenticated priority and transmit the authentication request described above to the authentication server 150 to obtain the priority of the accessing device 110. This embodiment is further described with reference to FIG. 4 of the present application.

Also, the network element may obtain the threshold priority of the gateways connected to the RAN 140 such as the first gateway 170 and the second gateway 180 using the A11 interface, which is one example of the interface between the RAN 140 and the core network 160. Alternatively, instead of using the A11 interface, the network element may obtain the threshold priority for each of the gateways connected to the RAN 140 from a storage unit of the network element, which may store predetermined threshold priorities for the connected gateways. Each of the threshold priorities for one gateway may correspond to a different time period such as 9:00 am-12:00 pm. Therefore, if the accessing device 110 wishes to connect to the first gateway 170 during this time period, the network element would obtain the threshold priority corresponding to this time duration for the first gateway 170 from the storage unit, and use this threshold priority in step S220.

In one particular embodiment, the accessing device 110 may be an M2M machine that has been assigned a relatively lower priority. Also, the accessing device may be a user hand-held device that has been assigned a relatively higher priority. The threshold priority of the gateway is a level of priority that indicates whether the gateway will accept or deny connection requests, as further explained below.

In step S230, the network element grants the connection request based on the priority of the accessing device 110 and the threshold priority of the gateway, which have been obtained in step S220.

In one embodiment, if the priority of the accessing device 110 is equal to or greater than the threshold of the first gateway 170 (assuming that the first gateway 170 is the gateway the device 110 wishes to connect to), the network element would grant the connection request and the elements in the RAN 140 and the core network 160 would perform normal signaling to carry out the requested service of the connection request. Each of the priority of the accessing device 110 and the threshold priority of a particular gateway may be information indicating a value. As such, when the value of the priority of the accessing device 110 is equal to or exceeds the value of the threshold priority, the network element may grant access to the core network 160. On the other hand, the network element denies the connection request if the priority of the accessing device 110 is less than the threshold priority.

If the network element denies the connection request, the network element may transmit information indicating that the core network 160 is congested and a time value indicating a time duration that the accessing device 110 must wait before attempting to re-transmit the connection request.

Alternatively, if the network element denies the connection request to the first gateway 170, the network element may attempt to connect the accessing device 110 to the second gateway 180. For example, after the network element denies the connection request to the first gateway 170, the network element compares the priority of the accessing device 110 to the threshold priority of the second gateway 180. If the priority of the accessing device 110 is equal to or greater than the priority of the second gateway 180, the network element would grant the connection request to the second gateway 180. Similarly, if the priority of the accessing device 110 is below the threshold priority of the second gateway 180, the network device denies access to the second gateway 180.

FIG. 3 illustrates a method for controlling congestion in the core network 160 according to another embodiment.

In step S301, the network element in the RAN 140 receives information indicating the threshold priority from each gateway connected to the RAN 140 over the A11 interface. For example, each of the first gateway 170 and the second gateway 180 may be provisioned to periodically issue an A11 message containing the threshold priority. Also, each of the first gateway 170 and the second gateway 180 may be provisioned to issue the A11 message containing the threshold priority when it detects or is informed of congestion or an overload condition. The network element stores the received threshold priorities in a storage unit of the network element. Step S301 indicates that the network element receives the threshold priority information from the first gateway 170. However, the network element may receive respective threshold priority information from each gateway connected to the RAN 140. The network element stores the threshold priority information in association with its respective gateway.

In step S302, the network element transmits an acknowledgment message indicating that the network element has received the threshold priority information to the first gateway 170. Alternatively, instead of receiving the threshold priority information via the A11 interface in step S301, as explained above, the network element may obtain the threshold priority information for the first gateway 170 or any other connected gateway from an internal storage unit.

In step S303, the device 110 and the network element included in the RAN 140 establish a radio session. The signaling between the network element and the device 110 to establish the radio session is well known to a person having ordinary skill in the art, and therefore the details of such signaling are omitted for the sake of brevity.

In step S304, the network element receives a connection request from the device 110. The connection request may be a request when the device 110 wishes to configure a session (e.g., HRPD ConnectionRequest), as explained in step S303, or when the device 110 opens flow control (e.g., XonRequest) or when the device with a session and open flow control wants to open a radio bearer. Further, the connection request may include an unauthenticated priority of the device 110. However, this feature is further explained with reference to FIG. 4 of the present application.

In step S305, the network element included in the RAN 140 and the device 110 perform signaling to negotiate a connection such as a RAN-level PPP connection. The signaling between the network element and the device 110 to negotiate a connection is well known to a person having ordinary skill in the art, and therefore the details of such signaling are omitted for the sake of brevity.

In step S306, the network element included in the RAN 140 and the device 110 perform signaling to obtain authentication credentials from the device 110. The signaling between the network element in the RAN 140 and the device 110 for authentication is well known to a person having ordinary skill in the art, and therefore the details of such signaling are omitted for the sake of brevity.

After obtaining the authentication credentials from the device 110, in step S307, the network element included in the RAN 140 transmits an authentication request in order to authenticate an identity of the accessing device to the authentication server 150 over the A12 interface, as described above.

In response, in step S308, the network element receives an authentication response from the authentication server 150 that includes conventional authentication information that indicates that the accessing device 110 is authenticated. If the accessing device is authenticated, in addition to the conventional authentication information, the authentication response includes information indicating the priority of the accessing device 110. In other words, the embodiments provide an additional field within an A12 message that carries the priority of the access device 110.

In step S309, the network element compares the priority of the accessing device 110 to the priority threshold of the first gateway 170. The network element grants the connection request if the priority of the accessing device 110 is equal to or greater than the threshold priority of the first gateway 170. For example, if the priority of the accessing device 110 is equal to or greater than the threshold priority, the network element performs normal signaling with the first gateway 170 in order to connect the accessing device to carry out the requested service. On the other hand, the network element denies the connection request if the priority of the accessing device 110 is less than the threshold priority.

If the network element denies the connection request, in step S310, the network element transmits information indicating that the core network 160 is congested and a time value indicating a time duration that the accessing device must wait before attempting to re-transmit the connection request.

FIG. 4 illustrates a method for controlling congestion in the core network 160 according to another embodiment.

Steps S401-S403 of FIG. 4 are the same as steps S301-S303 of FIG. 3. However, in step S404, the network element included in the RAN 140 receives an unauthenticated priority of the device 110 in the connection request.

In step S405, the network element compares the unauthenticated priority of the device 110 of the connection request to the threshold priority obtained in step S401. If the unauthenticated priority of the device 110 is below the threshold priority of the first gateway 170, the network element denies the connection request to the first gateway 170, and, in step S406, transmits information indicating that the core network 160 is congested and a time value indicating a time duration that the accessing device 110 must wait before attempting to re-transmit the connection request, which is the same as step S310 of FIG. 3. However, if the unauthenticated priority of the device 110 is equal to or greater than the threshold priority of the first gateway 170, the network element performs steps S307 and S308 of FIG. 3 in order to obtain the priority of the accessing device 110 from the authentication server 150 via the A12 interface.

Variations of the example embodiments are not to be regarded as a departure from the spirit and scope of the example embodiments, and all such variations as would be apparent to one skilled in the art are intended to be included within the scope of this disclosure.

What is claimed:

1. A system for congestion control in a core network, the core network including a plurality of gateways, the system comprising:
a network element configured to receive a connection request from an accessing device, the connection request requesting connection to a first gateway of the plurality of gateways, the network element being included in a radio access network (RAN),
the network element configured to obtain a priority of the accessing device and a threshold priority of the first gateway,
the network element configured to grant the connection request based on the priority of the accessing device and the threshold priority of the first gateway.

2. The system of claim 1, wherein the network element is configured to grant the connection request if the priority of the accessing device is equal to or greater than the threshold priority of the first gateway, and the network element configured to deny the connection request if the priority of the accessing device is less than the threshold priority of the first gateway.

3. The system of claim 1, wherein
the network element is configured to transmit an authentication request to authenticate an identity of the accessing device to an authentication server over a first interface in response to the connection request, the first interface being an interface between the network element and the authentication server,
the network element is configured to receive an authentication response including information indicating the priority of the accessing device in response to the authentication request if authentication is successful.

4. The system of claim 3, wherein the connection request includes information indicating an unauthenticated priority of the accessing device, and
the network element is configured to determine the unauthenticated priority as the priority of the accessing device if the unauthenticated priority is below the threshold priority, and
if the unauthenticated priority is equal to or greater than the threshold priority, the network element is configured to transmit the authentication request and receive the authentication response including the information indicating the priority of the accessing device along the first interface.

5. The system of claim 1, wherein the network element is configured to receive information indicating the threshold priority from the first gateway over a second interface, the second interface being an interface between the first gateway and the network element.

6. The system of claim 5, wherein the network element is configured to receive the information indicating the threshold priority if the first gateway detects an overload condition.

7. The system of claim 1, wherein the network element is configured to obtain the threshold priority from a storage unit of the network element.

8. The system of claim 7, wherein the network element is configured to obtain a different threshold priority from the storage unit at an indicated time.

9. The system of claim 1, wherein the network element is configured to grant a connection request to a second gateway of the plurality of gateways if (1) the network element denied the connection request to the first gateway and (2) the priority of the accessing device is greater than or equal to a threshold priority of the second gateway.

10. The system of claim 1, wherein the network element is configured to transmit information indicating network congestion and a time value indicating a time duration that the accessing device must wait before attempting to re-transmit the connection request if the network element denies the connection request.

11. The system of claim 1, wherein the network element includes an internal authentication mechanism that permits the network element to obtain the priority of the accessing device and the priority of the first gateway.

12. The system of claim 1, wherein the network element is one of a base station and radio network controller.

13. A method for congestion control in a core network, the core network including a plurality of gateways, the method comprising:
receiving, by a network element, a connection request from an accessing device, the connection request requesting connection to a first gateway of the plurality of gateways, the network element being included in a radio access network (RAN);
obtaining a priority of the accessing device and a threshold priority of the first gateway; and
granting the connection request based on the priority of the accessing device and the threshold priority of the first gateway.

14. The method of claim 13, wherein the granting step further includes:
granting the connection request if the priority of the accessing device is equal to or greater than the threshold priority of the first gateway; and
denying the connection request if the priority of the accessing device is less than the threshold priority of the first gateway.

15. The method of claim 13, wherein the obtaining step further includes:
transmitting an authentication request to authenticate an identity of the accessing device to an authentication server over a first interface in response to the connection request, the first interface being an interface between the network element and the authentication server; and
receiving an authentication response including information indicating the priority of the accessing device in response to the authentication request if authentication is successful.

16. The method of claim 15,
wherein the connection request includes information indicating an unauthenticated priority of the accessing device,
wherein the obtaining step further includes,
determining the unauthenticated priority as the priority of the accessing device if the unauthenticated priority is below the threshold priority, and
if the unauthenticated priority is equal to or greater than the threshold priority, transmitting the authentication request and receiving the authentication response including the information indicating the priority of the accessing device along the first interface.

17. The method of claim 13, wherein the obtaining step further includes:
receiving information indicating the threshold priority from the first gateway over a second interface, the second interface being an interface between the first gateway and the network element.

18. The method of claim 17, wherein the receiving step receives the information indicating the threshold priority when the first gateway detects an overload condition.

19. The method of claim 13, wherein the obtaining step further includes:
obtaining the threshold priority from a storage unit of a network element.

20. A system for congestion control in a core network, the core network including a plurality of gateways, the system comprising:
a network element configured to receive a connection request from an accessing device, the connection request requesting connection to a first gateway of the plurality of gateways, the network element not being included in the core network,
the network element configured to obtain a priority of the accessing device and a threshold priority of the first gateway,
the network element configured to grant the connection request based on the priority of the accessing device and the threshold priority of the first gateway.
